(19) United States
(12) Patent Application Publication
(10) Pub. No.: US 2011/0012297 A1
(43) Pub. Date: Jan. 20, 2011

(54) PATTERN TRANSFER METHOD

(76) Inventors: Ayumi KOBIKI, Kanagawa-ken (JP); Takeshi Koshiba, Mie-ken (JP); Hidefumi Mukai, Kanagawa-ken (JP); Seiro Miyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/718,778

(22) Filed: Mar. 5, 2010

(30) Foreign Application Priority Data
Jul. 17, 2009 (JP) P2009-169242

(51) Int. Cl. B29C 35/08; B29C 39/00

(52) U.S. Cl. 264/494; 264/299

(57) ABSTRACT

A pattern transfer method for transferring an uneven pattern onto a resist material is disclosed. The uneven pattern is formed in a template having a through-groove in a predetermined region. The resist material is applied to a substrate. The template is made to come into contact with the resist material. The resist material is filled to concave portion in the uneven pattern. The residual resist material leaked from a gap between the substrate and the template to the outside is sucked through the through-groove in a state where the template is in contact with the resist material. The resist material is made to cure in a state where the template is in contact with the resist material after the suction of the residual resist material. The template is separated from the cured resist material.

### CROSS REFERENCE TO RELATED APPLICATION

This application is based upon and claims the benefit of priority from the prior Japanese Patent Application No. 2009-169242, filed on Jul. 17, 2009, the entire contents of which are incorporated herein by reference.

### FIELD OF THE INVENTION

The invention relates to a pattern transfer method and, more particularly, to a pattern transfer method using an imprint lithography technique for transferring a microscopic pattern.

### DESCRIPTION OF THE BACKGROUND

In a semiconductor device manufacturing step, as a technique to satisfy both formation of a microscopic pattern and mass production, attention is paid to a nanoimprint technique of transferring an original template to a substrate to be transferred. A nanoimprint method is a method of pressing an original template in which a pattern to be transferred is formed against a resist applied to a substrate to be processed and the resist is hardened, thereby transferring the pattern formed in the original template to the resist.

According to the kind (curing method) of an imprint agent, the imprint lithography is classified to light (UV) imprint lithography, thermal imprint lithography, and the like. The light imprint lithography includes a step of applying a photo-curable imprint agent to a substrate to be processed, a step of aligning the substrate to be processed and a translucent template (alignment), a step of making the photo-curable imprint agent come into contact with the template, a step of curing the photo-curable imprint agent by light irradiation, and a step of releasing the template from the cured photo-curable imprint agent (resist pattern).

The action of making the imprint agent applied to the substrate to be processed come into contact with the template once is called “one shot”. By the above-described series of steps, a resist pattern formed by one shot is obtained. By step-and-repeat execution of the series of steps, imprint resist patterns arranged regularly on the substrate to be processed are formed. After that, a residual film removing step of removing a residual film of the photo-curable resist is performed and the substrate to be processed is etched using the resist pattern as a mask. In the method, the imprint agent is applied to the substrate to be processed shot by shot.

The imprint resist applying method includes a spin coating method and an ink jet method. In the case of the ink jet method, an imprint agent in a droplet state is applied to the substrate to be processed. In consideration of density of patterns to be imprinted and the like, an application quantity is controlled so that the imprint agent is applied to the inside of a predetermined pattern (hereinbelow, called a pattern for imprint) formed on the surface of the template facing the substrate to be processed.

In the case of the ink jet method, however, control of an application quantity of the picoliter order is demanded, and there is the case that the application amount varies. Consequently, by providing a predetermined region (hereinbelow, called a gap region) in the boundary with an adjacent shot, leakage of the imprint material of a residual amount to the adjacent pattern region is suppressed.

On the other hand, when the gap region is provided largely, a problem occurs that the gap region is damaged at the time of removing the residual film of the imprint agent. In addition, the number of chips which can be formed in a single wafer decreases. Consequently, it is desirable to form the gap region as small as possible. In the pattern transfer method disclosed in Japanese Patent Application Publication No. 2008-91782, a dummy groove to absorb the residual imprint agent is formed in attrition to the patterns in the template for pattern formation, thereby preventing leakage of the residual imprint agent to adjacent chips.

However, in the pattern transfer method disclosed in Japanese Patent Application Publication No. 2008-91782, it is difficult to fill the dummy groove with only the residual imprint agent and to accurately control the amount of the residual imprint agent. In the case where the application quantity varies, a fabrication of the pattern and the like is hindered, and it causes a problem that the yield decreases.

### SUMMARY OF THE INVENTION

One aspect of the invention is to provide a pattern transfer method for transferring an uneven pattern formed in a template onto a resist material applied to a substrate, the template having a through-groove in a predetermined region, includes: making the template come into contact with the resist material and filling a concave portion in the uneven pattern with the resist material; sucking the residual resist material leaked from a gap between the substrate and the template to the outside through the through-groove in a state where the template is in contact with the resist material; making the resist material cure in a state where the template is in contact with the resist material after the suction of the residual resist material; and separating the template from the cured resist material.

Another aspect of the invention is to provide a pattern transfer method for transferring an uneven pattern formed in a template onto a resist material applied to a substrate, the template having a through-groove in a predetermined region, includes: making the template come into contact with the resist material and filling a concave portion in the uneven pattern with the resist material; making the resist material cure except for the residual resist material leaked from a gap between the substrate and the template to the outside in a state where the template is in contact with the resist material; sucking the residual resist material through the through-groove in a state where the template is in contact with the resist material after the cure of the resist material; and separating the template from the cured resist material.

Still another aspect of the invention is to provide a pattern transfer method for making a template having a transfer pattern region in which an uneven pattern is formed and a non-pattern region in which the uneven pattern is not formed come into contact with a resist material applied to a substrate shot by shot and sequentially transferring the uneven pattern, wherein the adjacent shot in the shots is disposed so that at least a portion of the non-pattern region overlaps.

### BRIEF DESCRIPTION OF THE DRAWINGS

FIGS. 1A, 1B, 1C and 1D are step diagrams schematically showing a pattern transfer method by imprint lithography.

FIGS. 2A, 2B, 2C and 2D are step diagrams schematically showing the pattern transfer method by the imprint lithography.

FIG. 3 is a plan view and a cross-sectional view schematically showing a template used for a pattern transfer method according to a first embodiment of the invention.

FIG. 4 is a plan view schematically showing the template used for the pattern transfer method according to the first embodiment of the invention.

FIG. 5 is a plan view and a cross-sectional view schematically showing a template used for the pattern transfer method according to the first embodiment of the invention.

FIGS. 6A, 6B, 6C and 6D are cross-sectional views schematically showing the pattern transfer method according to the first embodiment of the invention.

FIGS. 7A, 7B, 7C and 7D are cross-sectional views schematically showing the pattern transfer method according to the first embodiment of the invention.

FIG. 8 is a cross-sectional view schematically showing a pattern transfer method according to the first embodiment of the invention.

FIG. 9 is a cross-sectional view schematically showing an imprint apparatus according to the first embodiment of the invention.

FIG. 10 is a plan view and a cross-sectional view schematically showing a template used for a pattern transfer method according to a second embodiment of the invention.

FIGS. 11A, 11B, 11C and 11D are cross-sectional views schematically showing the pattern transfer method according to the second embodiment of the invention.

FIGS. 12A, 12B, 12C and 12D are cross-sectional views schematically showing the pattern transfer method according to the second embodiment of the invention.

FIG. 13 is a plan view and a cross-sectional view schematically showing a template used for the pattern transfer method according to the second embodiment of the invention.

### DETAILED DESCRIPTION OF THE INVENTION

Embodiments of the invention will be hereinafter described with reference to the drawings.

### First Embodiment

A pattern transfer method by imprint lithography will be described below.

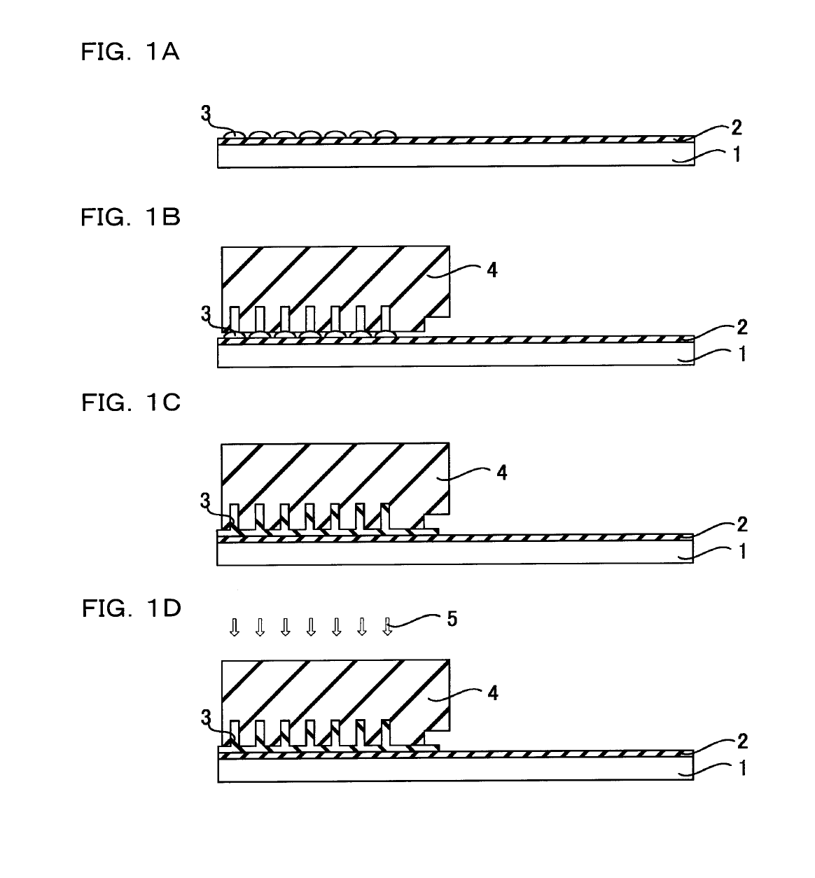

First, as shown in FIG. 1A, a photo-curable organic material (resist) 3 is applied to a film 2 to which a pattern is transferred on a substrate 1. The organic material 3 is applied as droplets of the organic material by the ink jet method.

Next, as shown in FIG. 1B, a template 4 on which a pattern of one shot is formed is allowed to come into contact with the organic material 3. After that, as shown in FIG. 1C, the template 4 is allowed to come into contact with a wafer. In this state, the template 4 is held until the organic material 3 penetrates microscopic patterns of the template 4.

Immediately after the template 4 is made contact, a filling defect occurs at corners of the pattern due to insufficient filling of the organic material 3. However, since the organic material 3 has flowability, by making the hold time longer, the organic material 3 spreads to every corner of the pattern by the capillary action. In this state, as shown in FIG. 1D, light (UV) 5 is irradiated to cure the organic material 3.

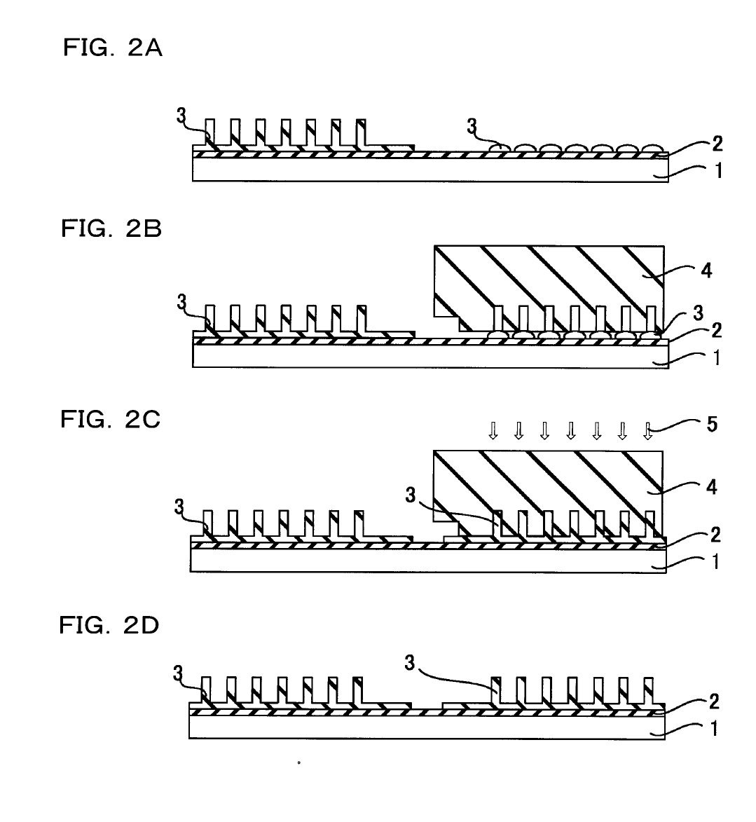

After the template 4 is separated from the organic material 3, as shown in FIG. 2A, the organic material 3 is applied to the adjacent resist pattern region. Subsequently, as shown in FIGS. 2B and 2C, a pattern is similarly formed also in the adjacent resist pattern region. FIG. 2D shows a state where the template 4 is separated from the organic material 3. By forming a gap region between the adjacent shots as shown in FIG. 2D, leakage of the imprint agent to the adjacent shot regions is prevented.

In the embodiment of the invention, the pattern transfer method capable of reducing, more preferably, eliminating the gap region is proposed. The pattern transfer method according to a first embodiment of the invention will be described below.

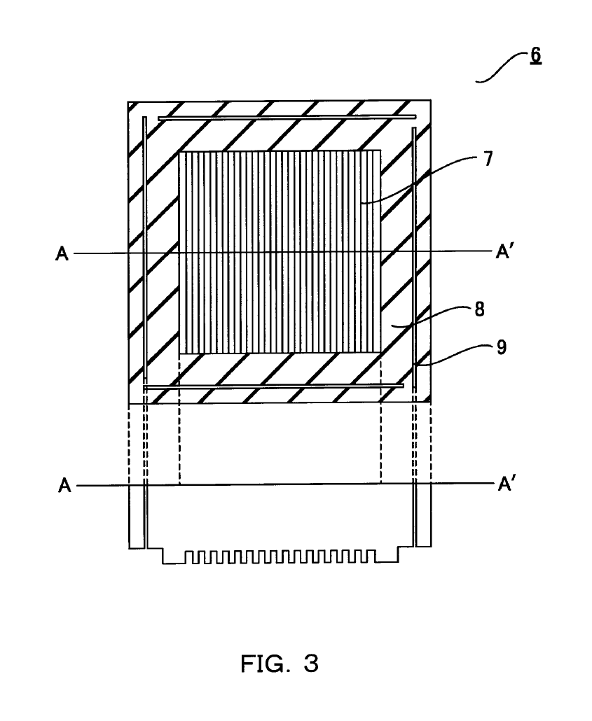

First, a plan view and a cross-sectional view of a template 6 used in the embodiment are shown in FIG. 3. As shown in FIG. 3, the center portion of the template 6 is made by a transfer pattern region 7 in which projections and depressions as a transfer pattern which is a line-and-space device pattern are formed for example, and a non-pattern region 8. Alignment marks for alignment or the like are normally formed around the transfer pattern region 7 but are not shown. Suction grooves 9 are provided in the non-pattern region 8 so as to surround the transfer pattern region 7. A region transferred onto the wafer by the transfer pattern region 7 is a chip region.

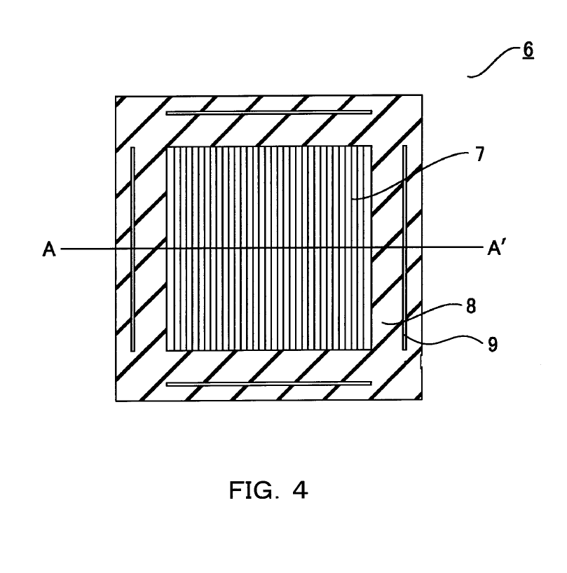

In FIG. 3, the suction groove 9 is formed continuously so as to surround the transfer pattern region 7 except for the corners of the transfer pattern region 7. The shape of the suction groove 9 is not limited to the above but various shapes are possible. As shown in FIG. 4, preferably, the suction grooves 9 having the same length as each of the sides of the transfer pattern region 7 are formed so as to face each other around the transfer pattern region 7.

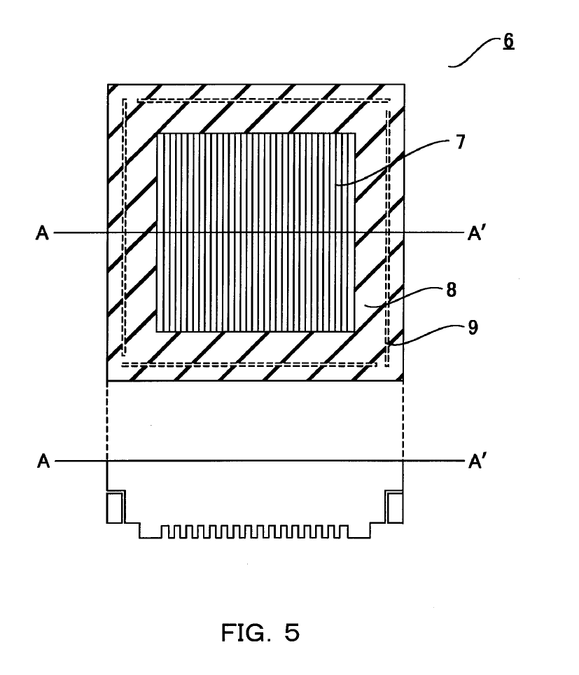

The suction groove 9 does not always have to be a through-groove having openings in the top and bottom faces of the template 6. As shown in FIG. 5, the suction groove 9 may be a through-groove having openings in bottom and side faces of the template 6.

Subsequently, a pattern transfer method by nanoimprint method according to the first embodiment of the invention will be described below.

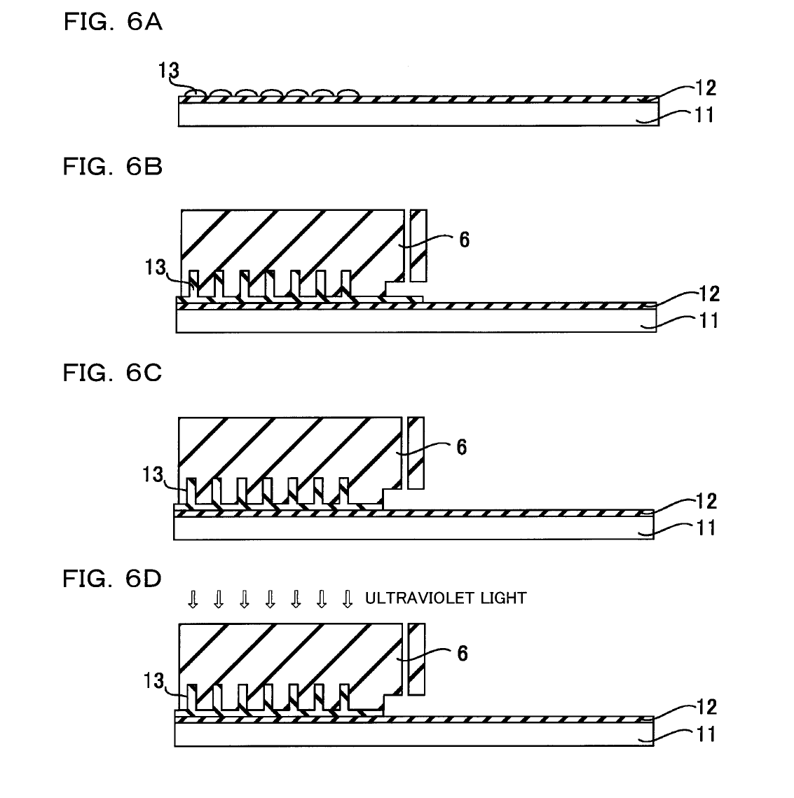

First, as shown in FIG. 6A, a substrate 11 to be processed on which an imprint agent 13 as a liquid photo-curable resin material is applied by an amount of one shot by the ink jet method is prepared. The substrate to be processed may be a silicon substrate itself, or a silicon substrate on which a mask made by a silicon oxide film, an insulating film such as low-k (low-dielectric-constant) film, an organic film or the like is formed. In the embodiment, an object to be processed is set as an insulating film 12.

Next, the template 6 used in the foregoing embodiment is prepared. The template 6 is obtained by, for example, forming a pattern of projections and depressions (uneven pattern) in a totally transparent quartz substrate for use in a general photomask by plasma etching.

Subsequently, using the substrate 11 to be processed and the template 6 shown in FIG. 3, the alignment mask and the template 6 are allowed to come into contact as shown in FIG. 6B. In FIG. 6B, the face in which the pattern is formed of the template 6 shown in FIG. 3 faces downward and is in contact with the imprint agent 13.

As shown in FIG. 6B, the imprint agent 13 fills the grooves of the pattern formed in the template 6, and the residual imprint agent 13 leaks to the outside from the chip region. In the embodiment, the unnecessary residual imprint agent 13 is removed by being sucked from the suction grooves 9 formed in the template 6. Consequently, the residual imprint agent 13 is not leaked to the adjacent shot region on the insulating film 12 (FIG. 6C).

In the case of eliminating the residual imprint agent 13 by the dummy groove, the application quantity of the imprint agent 13 has to be determined in consideration the shape of the dummy groove as well. In the embodiment, only the unnecessary portion can be selectively eliminated by the suction groove 9, so that it is unnecessary to perform detailed control on the application amount.

After contact with the template, as shown in FIG. 6D, UV light such as i line is applied to make the imprint agent 13 photo-cured. After that, the template is separated, and the program advances to a residual film removing step (not shown), thereby completing a first resist pattern.

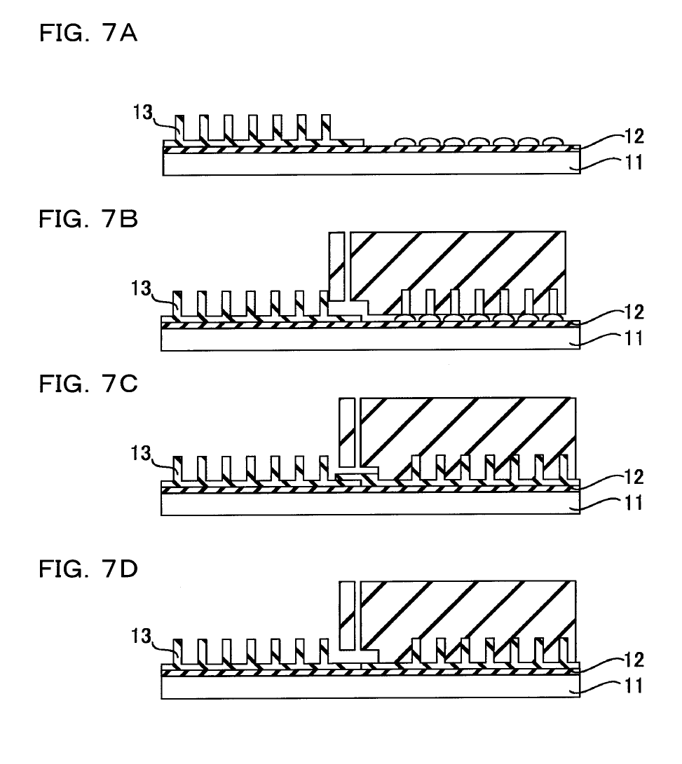

After the separation, as shown in FIG. 7A, the imprint agent 13 is applied to a shot region adjacent to the first resist pattern. Subsequently, as shown in FIGS. 7B and 7C, a second resist pattern is similarly formed also in the adjacent resist pattern region. In the case of shortening the distance between adjacent shots, as shown in FIG. 7C, there is the possibility that the residual imprint agent 13 leaks onto the first resist pattern in the adjacent shot region. In the case where a region doubly covered with the residual imprint agent 13 exists in a conventional technique, the resist may remain even after the step of removing the resist pattern (ashing).

However, in the embodiment, as shown in FIG. 7D, the residual imprint agent 13 leaked onto the resist pattern on the adjacent shot region can be selectively removed by the suction grooves 9. Consequently, the distance between adjacent shots can be decreased. In addition, adhesion of the residual imprint agent 13 leaked to the outside of the shot to the side wall of the template 6 (the side wall of a step in the boundary of shots) can be prevented. The residual imprint agent 13 adhered to the side wall of the template 6 causes contamination of the template 6 and causes a defect. In the embodiment, the residual imprint agent 13 adhered to the side wall of the template 6 can be removed, so that occurrence of a defect can be prevented.

The following step is a step of applying UV light to make the imprint agent 13 photo-cured and releasing the template like the step of forming the first resist pattern, so that detailed description will not be repeated.

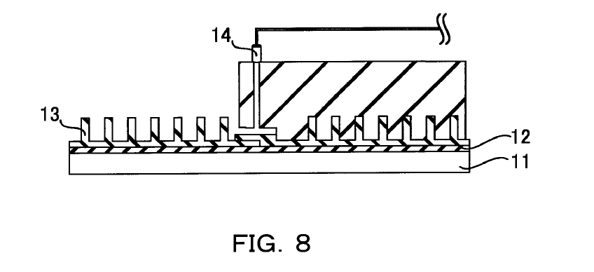

The suction method will now be described. For example, as shown in FIG. 8, a method of connecting a drivable suction head 14 to the opening of the suction groove 9 and sucking the residual imprint agent 13, and a method of providing a pressure difference between the top and bottom faces of the template 6 and sucking the residual imprint agent 13 are considered.

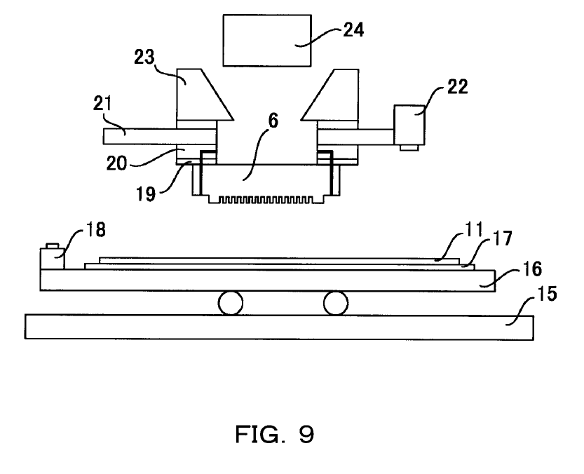

FIG. 9 shows an example of the configuration of an imprint apparatus that sucks the residual imprint agent 13 by providing a pressure difference between the top and bottom faces of the template 6. A wafer as the substrate 11 to be processed is mounted on a wafer chuck 17 provided on a sample stage 16 on a stage plate 15. The sample stage 16 is provided with a reference mark 18 for alignment. Below an original plate stage 20 provided on the substrate 11 to be processed, the template 6 is held by a chuck 19 so as to face the substrate 11 to be processed.

In the chuck 19, a through-groove connected to the suction groove 9 in the template 6 is formed. The through-groove connects the suction groove 9 and a suction groove formed in the original plate stage 20. The suction groove formed in the original plate stage 20 can exhaust the sucked residual imprint agent 13. The original plate stage 20 is connected to a base 21 of the imprint apparatus. In the embodiment, the original plate stage 20 has an exhaust port of the residual imprint agent 13. The configuration of the original plate stage 20 is not limited above. Various configurations are possible. For example, a through-groove may be provided in the original plate stage 20, and an exhaust port may be formed in the base 21.

The base 21 is provided with a misalignment testing mechanism 22 and an alignment sensor 23 for adjusting the imprint position, and a UV light source 24 is provided above the base 21 and the template 6. In the imprint apparatus shown in FIG. 9, by making the pressure on the exhaust port side lower than that on the suction groove 9 side of the template 6, the residual imprint agent 13 can be sucked.

As described above, by using the pattern transfer method according to the first embodiment of the invention, leakage of the residual imprint material to an adjacent chip can be prevented, and the fraction defective of the chips can be reduced. Further, the gap region between shots can be reduced, more preferably, eliminated. In addition, only the unnecessary portion can be selectively eliminated by the suction groove 9. Consequently, it is unnecessary to perform detailed control on the quantity of the residual imprint agent, and the pattern transfer is can be easy performed.

### Second Embodiment

Subsequently, a pattern transfer method by the nanoimprint method according to a second embodiment of the invention will be described. The second embodiment is different from the first embodiment with respect to the point that a light shield film is formed in a predetermined region on a template.

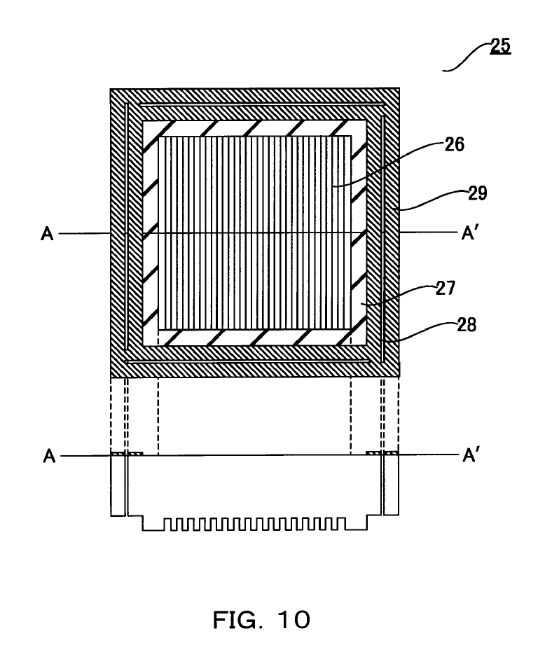

A plan view and a cross-sectional view of a template 25 used in the embodiment are shown in FIG. 10. As shown in FIG. 10, the center portion of the template 25 is made by, for example, a transfer pattern region 26 in which projections and depressions as a transfer pattern which is a line-and-space device pattern are formed and a non-pattern region 27. Alignment marks for alignment or the like are normally formed around the transfer pattern region 26 but are not shown. Suction grooves 28 are provided in the non-pattern region 27 so as to surround the transfer pattern region 26. A region transferred onto the wafer by the transfer pattern region 26 is a chip region.

Further, in a region at least on the outside area from the opening of the suction groove 28 of the top surface of the template 25, a light shield film or a semi-transparent film 29 made of chromium (Cr) or the like is formed. The light shield film or semi-transparent film 29 has an effect of preventing an unnecessary imprint agent from being irradiated with light and being cured.

Preferably, the light shield film or the semi-transparent film 29 is formed on the inside area from the opening of the suction groove 28 as long as it has a size which does not disturb resist curing in the transfer pattern region 26. When the light shield film or the semi-transparent film 29 is formed on the inside area from the opening of the suction groove 28, oblique incident light can be also prevented. Thus, the light shield efficiency can be further improved.

In FIG. 10, the suction groove 28 is formed continuously so as to surround the transfer pattern region 26 except for the corners of the transfer pattern region 26. The shape of the suction groove 28 is not limited to the above but various shapes are possible. Preferably, the suction grooves 28 having the same length as each of the sides of the transfer pattern region 26 are formed so as to face each other around the transfer pattern region 26.

The suction groove 28 does not always have to be a through-groove having openings in the top and bottom faces of the template 25 but may be a through-groove having openings in bottom and side faces of the template 25.

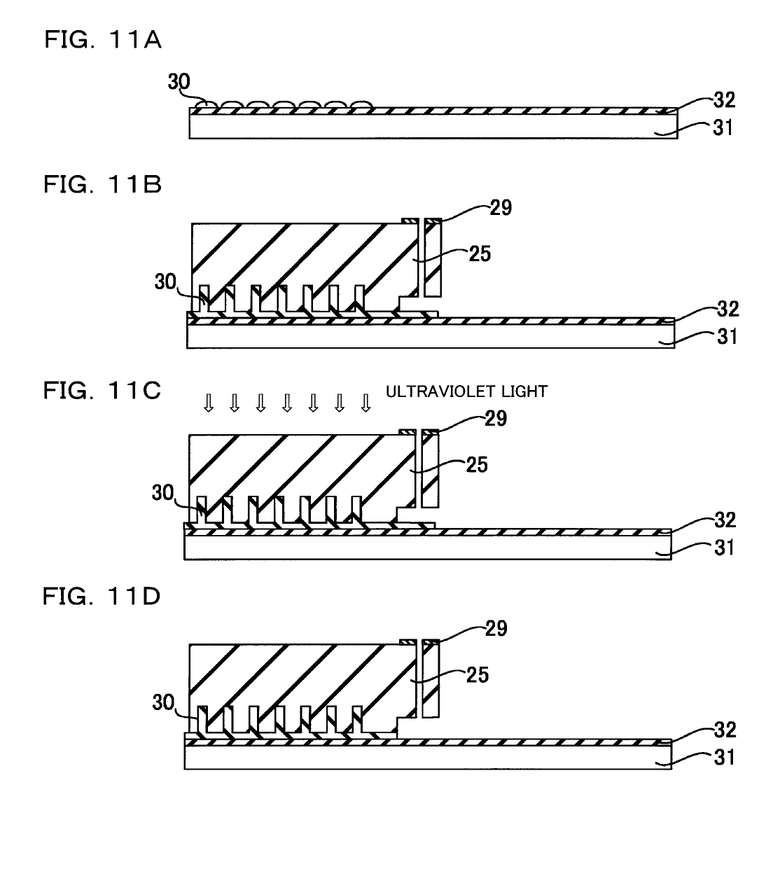

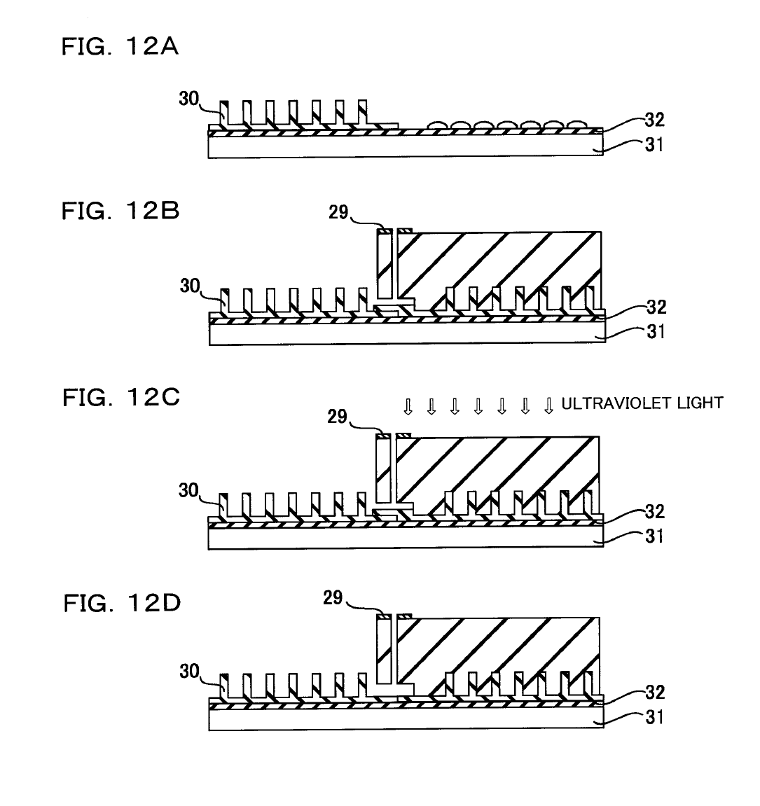

Subsequently, a pattern transfer method by nanoimprint method according to the second embodiment of the invention will be described below with reference to FIGS. 11A to 11D and FIGS. 12A to 12D.

First, as shown in FIG. 11A, a substrate 31 to be processed on which an imprint agent 30 as a liquid photo-curable resin material is applied by an amount of one shot by the ink jet method is prepared. The substrate to be processed may be a silicon substrate itself, or a silicon substrate on which a mask made by a silicon oxide film, an insulating film such as low-k (low-dielectric-constant) film, an organic film or the like is formed. In the embodiment, an object to be processed is set as an insulating film 32.

Next, the template 25 used in the foregoing embodiment is prepared. The template 25 is obtained by, for example, forming a pattern of projections and depressions in a totally transparent quartz substrate for use in a general photomask by plasma etching.

Subsequently, using the substrate 31 to be processed and the template 25 shown in FIG. 10, the alignment mask and the template are allowed to come into contact as shown in FIG. 11B. In FIG. 11B, the face in which the pattern is formed of the template 25 shown in FIG. 10 faces downward and is in contact with the imprint agent 30. As shown in FIG. 11B, the imprint agent 30 fills the grooves of the pattern formed in the template 25, and the residual imprint agent 30 leaks to the outside from the chip region.

Next, as shown in FIG. 11C, UV light such as i line is applied to make the imprint agent 30 photo-cured. Since the light shield film 29 is formed in the template 25, the residual imprint agent 30 leaked to the outside of the chip region is not illuminated with light and not cured.

After the light irradiation, the unnecessary residual imprint agent 30 is sucked and eliminated by the suction groove 28 formed in the template 25. Consequently, the residual imprint agent 30 is not leaked to an adjacent shot region on the insulating film 32 (FIG. 11D). By making the necessary pattern cure before suction of the residual imprint agent 30, the necessary imprint agent 30 can be prevented from being sucked. Thus, a pattern can be transferred more accurately as compared with the foregoing first embodiment.

After the suction, the template is separated, and the residual film is removed, thereby a first resist pattern is completed. In the case of eliminating the residual imprint agent 30 by the dummy groove, the application quantity of the imprint agent 30 has to be determined in consideration of the shape of the dummy groove. In the embodiment, only the unnecessary portion can be selectively eliminated by the suction groove 28, so that it is unnecessary to perform detailed control of the application amount.

After the separation, as shown in FIG. 12A, the imprint agent 30 is applied to a shot region adjacent to the first resist pattern. Subsequently, as shown in FIG. 12B, a pattern is similarly formed also in the adjacent resist pattern region. As shown in FIG. 12B, in the case of shortening the distance between adjacent shots, the residual imprint agent 30 leaks onto the first resist pattern in the adjacent shot region.

Subsequently, as shown in FIG. 12C, UV light such as i line is applied to make the imprint agent 30 photo-cured. Since the light shield film 29 is formed in the template 25, the residual imprint agent 30 leaked to the outside of the chip region is not irradiated with light and is not cured. After light irradiation, the unnecessary residual imprint agent 30 leaked on the first resist pattern is sucked from the suction groove 28 formed in the template 25 and eliminated.

In the embodiment, as shown in FIG. 12D, the residual imprint agent 30 leaked on the resist pattern in the adjacent shot region can be selectively removed by the suction groove 28. Consequently, the distance between adjacent shots can be decreased. Since the following step is a step of releasing the template like the step of forming the first resist pattern, the detailed description will not be repeated. As for a suction method, a method similar to that in the foregoing first embodiment can be used.

As described above, by using the pattern transfer method according to the second embodiment of the invention, leakage of the residual imprint material to an adjacent chip can be prevented, and the defective fraction of the chips can be reduced. Further, the gap region between shots can be reduced, more preferably, eliminated. In addition, only the unnecessary portion can be selectively eliminated by the suction groove 28. Consequently, it is unnecessary to perform detailed control on the amount of the residual imprint agent, and the pattern transfer is can be easily performed.

Further, since the light shield film 29 is formed in the predetermined region in the template 25, an effect of preventing an unnecessary imprint agent from being irradiated with light and being cured is obtained.

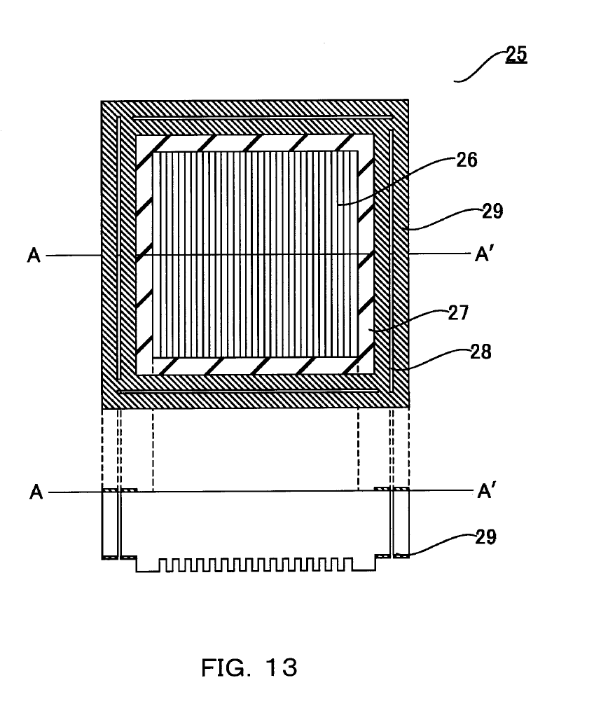

The invention is not limited to the foregoing embodiments and various other modifications are possible without departing from the scope of the invention. For example, as shown in FIG. 13, the light shield film 29 may be formed also on the under face of the template 25. By forming the light shield film 29 also on the under face of the template 25, the efficiency of blocking oblique incident light improves, and suction of the residual imprint agent can be performed efficiently. It is also possible to form the light shield film 29 only on the under face of the template 25.

The case of leaving a resist material formed in an overlapped non-pattern region by one of adjacent shots, and removing a resist material formed on the left resist material by the other shot has been described. On the contrary, it is also possible to remove the resist material formed in the overlapped non-pattern region by one of adjacent shots and leave the resist material formed in the region where the resist material has been removed by the other shot.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A pattern transfer method for transferring an uneven pattern formed in a template onto a resist material applied to a substrate, the template having a through-groove in a predetermined region, comprising:
making the template come into contact with the resist material and filling a concave portion in the uneven pattern with the resist material;
sucking the residual resist material leaked from a gap between the substrate and the template to the outside through the through-groove in a state where the template is in contact with the resist material;
making the resist material cure in a state where the template is in contact with the resist material after the suction of the residual resist material; and
separating the template from the cured resist material.

2. The pattern transfer method according to claim 1, wherein the through-groove is formed around a transfer pattern region having the uneven pattern, the through-groove has at least the same length as each of sides of the transfer pattern region and faces the transfer pattern region.

3. The pattern transfer method according to claim 1, wherein the residual resist material is sucked through the through-groove by a pressure difference between an under surface and a top surface of the template, the uneven pattern is formed in the under surface of the template.

4. The pattern transfer method according to claim 3, wherein the pressure difference is provided by connecting a suction head to an opening of the through-groove formed in the template.

5. The pattern transfer method according to claim 3, wherein the pressure difference is provided by an imprint apparatus which includes: an original plate stage having a suction groove; and a chuck fixing the template to the original plate stage and having a through groove to connect the through-groove in the template with the suction groove in the original plate stage, and the imprint apparatus is configured to exhaust in the suction groove in the original plate stage.

6. The pattern transfer method according to claim 1, wherein the resist material is made to cure by irradiating the resist material with a light.

7. A pattern transfer method for transferring an uneven pattern formed in a template onto a resist material applied to a substrate, the template having a through-groove in a predetermined region, comprising:
making the template come into contact with the resist material and filling a concave portion in the uneven pattern with the resist material;
making the resist material cure except for the residual resist material leaked from a gap between the substrate and the template to the outside in a state where the template is in contact with the resist material;
sucking the residual resist material through the through-groove in a state where the template is in contact with the resist material after the cure of the resist material; and
separating the template from the cured resist material.

8. The pattern transfer method according to claim 7, wherein the through-groove is formed around a transfer pattern region in which the uneven pattern is formed, the through-groove has at least the same length as each of sides of the transfer pattern region and faces the transfer pattern region.

9. The pattern transfer method according to claim 7, wherein the resist material is made to cure by irradiating the resist material with a light expect for the residual resist material.

10. The pattern transfer method according to claim 9, wherein a light shield film to cover the residual resist material is formed on an under surface and/or a top surface of the template, the uneven pattern is formed on the under surface of the template.

11. The pattern transfer method according to claim 10, wherein the light shield film is formed in a region on the outside area from an opening of the suction groove.

12. The pattern transfer method according to claim 10, wherein the light shield film is formed in a region on the outside and the inside area from an opening of the suction groove.

13. The pattern transfer method according to claim 7, wherein the residual resist material is sucked through the through-groove by a pressure difference between an under surface and a top surface of the template, the uneven pattern is formed in the under surface of the template.

14. The pattern transfer method according to claim 13, wherein the pressure difference is provided by connecting a suction head to an opening of the through-groove formed in the template.

15. The pattern transfer method according to claim 13, wherein the pressure difference is provided by an imprint apparatus which includes: an original plate stage having a suction groove; and a chuck fixing the template to the original plate stage and having a through groove to connect the through-groove in the template with the suction groove in the original plate stage, and the imprint apparatus is configured to exhaust in the suction groove in the original plate stage.

16. A pattern transfer method for making a template having a transfer pattern region in which an uneven pattern is formed and a non-pattern region in which the uneven pattern is not formed come into contact with a resist material applied to a substrate shot by shot and sequentially transferring the uneven pattern,
wherein the adjacent shot in the shots is disposed so that at least a portion of the non-pattern region overlaps.

17. The pattern transfer method according to claim 16, wherein a film thickness of the resist material formed in the overlapped non-pattern region is substantially equal to that of the resist material formed in the non-pattern region except for the overlapped non-pattern region.

18. The pattern transfer method according to claim 16, wherein the resist material formed in the overlapped non-pattern region by one of the adjacent shots is left, and the resist material formed on the left resist material by the other shot is removed.

19. The pattern transfer method according to claim 16, wherein the resist material formed in the overlapped non-pattern region by one of the adjacent shots is removed, and the resist material formed in a mark of the removed resist material by the other shot is left.
